(19) United States
(12) Patent Application Publication
(10) Pub. No.: US 2009/0106156 A1
(43) Pub. Date: Apr. 23, 2009

(54) Network-based DRM enforcement

(75) Inventors: Vinod K. Choyi, Ottawa (CA); Faud Khan, Osgoode (CA); Dmitri Vinokurov, Ottawa (CA)

Correspondence Address: KRAMER & AMADO, P.C., 1725 DUKE STREET, SUITE 240, ALEXANDRIA, VA, 22314, US

(73) Assignee: ALCATEL LUCENT, Paris (FR)

(21) Appl. No.: 11/976,248

(22) Filed: Oct. 23, 2007

(51) Int. Cl. G06F 17/40; H04L 9/32

(52) U.S. Cl. 705/59; 705/51

(57) ABSTRACT

A method of network-based digital rights enforcement, and related enforcement device, the method including one or more of the following: embedding information into digital content requested by an end user; providing a signature for the digital content to a service provider; providing a key to the service provider, the key being necessary for reading the information embedded into the digital content; providing an algorithm to the service provider for extracting the information embedded into the digital content; providing an identification to the service provider of a content provider that provides the digital content; extracting the signature from the digital content requested by the end user; analyzing the signature to determine whether a signature match exists; and determining whether the end user is a legitimate authorized user of the requested digital content or capable of distributing content.

### BACKGROUND OF THE INVENTION

1. Field of the Invention

This invention relates generally to digital rights management.

2. Description of Related Art

Digital rights management (DRM) is an umbrella term that refers to access control technologies used by publishers and other copyright holders to limit usage of digital media or devices. DRM can also refer to restrictions associated with specific instances of digital works or devices. The proper use of the term does not necessarily technically include copy protection and technical protection measures.

Copy protection and technical protection measures are specific technologies that control or restrict the use and access of digital content on electronic devices. Thus, copy protection and technical protection measures can be components of a complete rights-management system design. Benefits of digital rights management include copyright holders preventing unauthorized duplication of their work to ensure continued revenue streams. In this context, there exists a need for network-based digital rights enforcement.

The foregoing objects and advantages of the invention are illustrative of those that can be achieved by the various exemplary embodiments and are not intended to be exhaustive or limiting of the possible advantages which can be realized. Thus, these and other objects and advantages of the various exemplary embodiments will be apparent from the description herein or can be learned from practicing the various exemplary embodiments, both as embodied herein or as modified in view of any variation which may be apparent to those skilled in the art. Accordingly, the present invention resides in the novel methods, arrangements, combinations and improvements herein shown and described in various exemplary embodiments.

### SUMMARY OF THE INVENTION

In light of the present need for network-based digital rights enforcement, a brief summary of various exemplary embodiments is presented. Some simplifications and omission may be made in the following summary, which is intended to highlight and introduce some aspects of the various exemplary embodiments, but not to limit its scope. Detailed descriptions of a preferred exemplary embodiment adequate to allow those of ordinary skill in the art to make and use the invention concepts will follow in later sections.

Digital rights enforcement has been generally seen as something that is enforced by the client digital rights management (DRM) application in conjunction with various components such as standard-compatible end-user's equipment for playing media. Often this equipment uses proprietary means specific for certain media producers or DRM solution provider only. Network operators and service providers have found it difficult to become part of the content delivery chain.

Service providers (SPs) have not been successful in defining their role and are worried that they may become just a transport system. However, by becoming associated with content providers (CPs), they have the opportunity to be a competitive entity in the battle between free content and paid content by providing digital rights enforcement. An ability to offer a unique, valuable network-based service on the content distribution control for content producers is believed to bring a competitive advantage for network equipment vendors.

Some embodiments are DRM solutions provided by content providers, content developers, operating system (OS) providers, and various media players. Standards including the Open Mobile Alliance (OMA) have also created DRM specifications. However, these standards and specifications mainly deal with digital rights enforcement performed by end-user applications. The interoperability of various embodiments of DRM solutions is a challenge, including several limitations such as the following.

A focus on the DRM controls in media playing devices suffers from a lack of interoperability. Further, sometimes, the individual producer's policies do not comply with one or more national regulations. Also, a personal media playing device is under full user's control. Thus, it can be “cracked” and replaced by pirate equipment. In general, this allows a user to get full control on the legitimate media being played in order to further distribute that media illegally.

A problem or limitation with some embodiments is that there is either absolutely no control or perhaps only a slight influence at the stage of illegal media distribution over the network run by the operator or access SP. It is believed to be desirable to have a role for the SPs and network operators, yet this is lacking from many embodiments. Instead, digital rights enforcement is often accomplished by various entities that involve a client DRM application, a content storage server, and a key distribution server.

In response to the foregoing, various exemplary embodiments utilize deep packet inspection (DPI) capability. Likewise, various exemplary embodiments make use of a digital object identifier (DOI).

In various exemplary embodiments a content provider embeds a universal content identifier (UCI) or a DOI into content and complements it with a network-based identity of the legitimate media recipient for each media transfer or download over the network. Thus, in various exemplary embodiments, a purchaser's Internet protocol (IP) address at the time of a media transfer is used as the purchaser's identity.

In various exemplary embodiments, the operator-run DPI entity on the access side of the network extracts the UCI. The UCI contains two other parts. One of the other parts identifies the content provider's identification (ID) and the second other part is the ID of the content.

In various exemplary embodiments, based upon the recognized content provider's ID and media recipient's identity, the DPI system takes an appropriate action. These actions may include one or more of the following: redirecting the customer to the particular uniform resource locator (URL) of the content provider; taking the customer to the website of a clearing house or a web site that provides license and keys, where the customer then pays for the license; injecting the content producer's advertisement promoting and/or offering a legitimate content purchase of the content in question; and counting statistics for use by the CP, the statistics including, for example, volume of legitimate and illegitimate use of the particular content.

### BRIEF DESCRIPTION OF THE DRAWINGS

In order to better understand various exemplary embodiments, reference is made to the accompanying drawings, wherein:

FIG. 1 is a schematic diagram of an exemplary system of network-based digital rights enforcement;

FIG. 2 is a flow chart of an exemplary method of network-based digital rights enforcement;

FIG. 3 is an exemplary table of data for use in network-based digital rights enforcement; and

FIG. 4 is a schematic diagram of an exemplary embodiment of embedded information and exemplary use of same in network-based digital rights enforcement.

### DETAILED DESCRIPTION OF THE PREFERRED EMBODIMENTS OF THE INVENTION

Referring now to the drawings, in which like numerals refer to like components or steps, there are disclosed broad aspects of various exemplary embodiments.

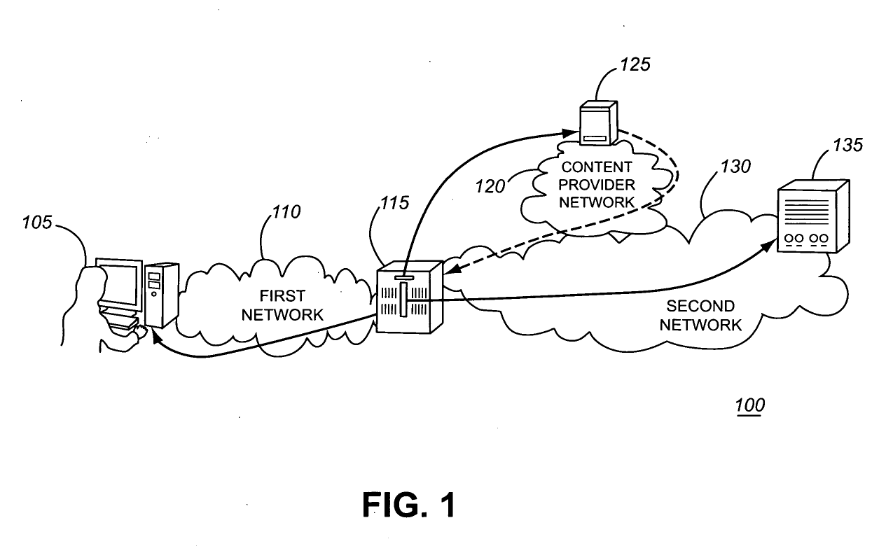

FIG. 1 is a schematic diagram of an exemplary system 100 of network-based digital rights enforcement. Exemplary system 100 includes an end user 105, a first network 110, a digital rights enforcement device (DRED) 115, a content provider network 120, a content provider server 125, a second network 130 and a distributor 135.

In various exemplary embodiments, the distributor 135 is a legitimate distributor of content. In other exemplary embodiments, the distributor 135 is an illegitimate distributor of content. In various exemplary embodiments, the distributor 135 communicates with the DRED through the second network 130. In various exemplary embodiments, the second network is the Internet. In various exemplary embodiments, the DRED 115 communicates with the end user 105 through the first network 110. In various exemplary embodiments, the first network 110 is an access network. In various exemplary embodiments the first network 110 is either a fixed access network such as DSL, Cable etc., or a mobile access network such as UMTS, CDMA200, WiMax or any other known or later developed wireless/mobile access network.

In various exemplary embodiments, the end user 105 functions as a distributor to another end user (not pictured). Similarly, in various exemplary embodiments, the distributor 135 is another end user. Accordingly, it should be understood that various references herein to the distributor 135 are also applicable to the end user 105 or another end user functioning as a distributor of content.

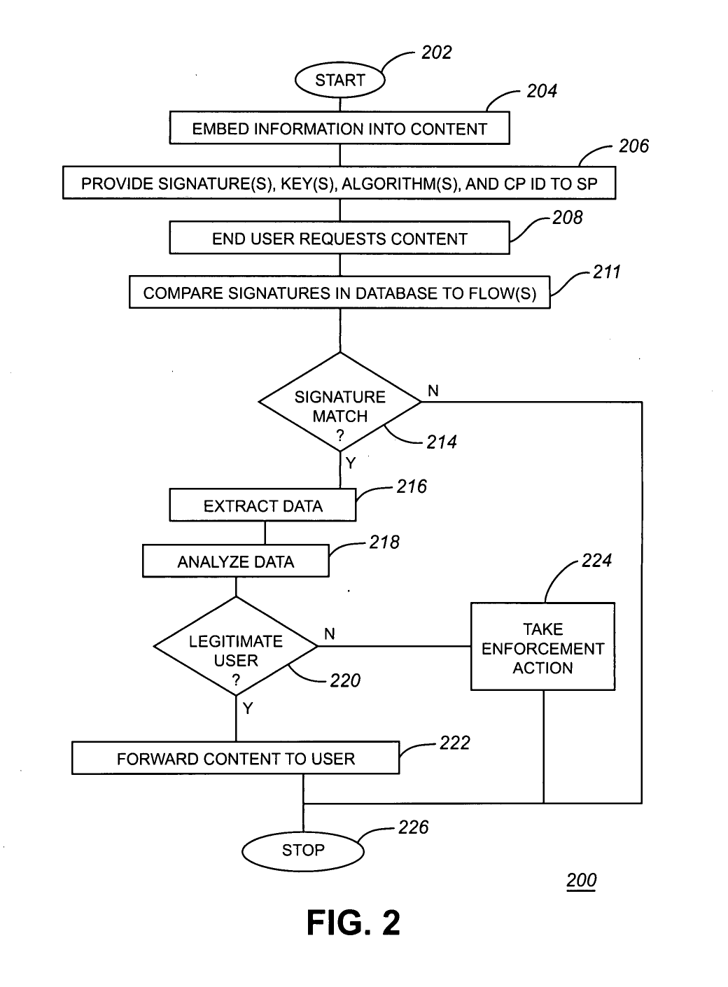

FIG. 2 is a flow chart of an exemplary method 200 of network-based digital rights enforcement. The method 200 starts in step 202 and continues to step 204. In step 204, information is embedded into content.

In various exemplary embodiments, the CP embeds information into the content in step 204 such that, when the content is sent over a network such as the second network 130, the content can be identified. Similarly, in various exemplary embodiments, the CP embeds information into the content in step 204 so that, when the content is sent over a network such as the second network 130, the owner of the content can be identified.

In various exemplary embodiments, a messages authentication code (MAC) of the embedded information is also inserted into the content. In various exemplary embodiments, the MAC is utilized to control the integrity of the embedded information in the content. This ensures that the embedded information within the content has not been modified. In various exemplary embodiments, the information embedded into the content is encrypted. In various exemplary embodiments, when a legitimate purchaser of the content purchases the content, the CP embeds the information into the content in order to identify that content as legitimately purchased, or otherwise authorized, by the CP.

In various exemplary embodiments, the information embedded into the content is embedded by the CP into the content in connection with a purchase of the content by the end user 105. This will be discussed in greater detail below in connection with subsequent steps of the method 200.

In various exemplary embodiments, the information embedded into the content includes a purchaser's identification (PID). The PID is, in various exemplary embodiments, an IP multi media subsystem (IMS) public identity, an IP address, and so on.

In various exemplary embodiments, the information embedded into the content in step 204 includes a content identification (ID). In various exemplary embodiments, a content ID is the DOI, or some other UCI that has parts that identify the CP and the content.

In various exemplary embodiments, the information embedded into the content in step 204 includes a MAC calculated based on the combination of the PID and UCI or the combination of the PID and DOI. In various exemplary embodiments, the PID and UCI are also encrypted.

Following step 204, the method 200 proceeds to step 206. In step 206, the signatures, keys, algorithms, and CP IDs are provided to the SP. It should be evident that, in various exemplary embodiments, only one signature, one key or one algorithm may be provided, while in other exemplary embodiments, a plurality of signatures, a plurality of keys or a plurality of algorithms may be provided. Similarly, it should be apparent that, in various exemplary embodiments, one or more of the signatures, keys and algorithms may be omitted from the information provided to the SP in step 206.

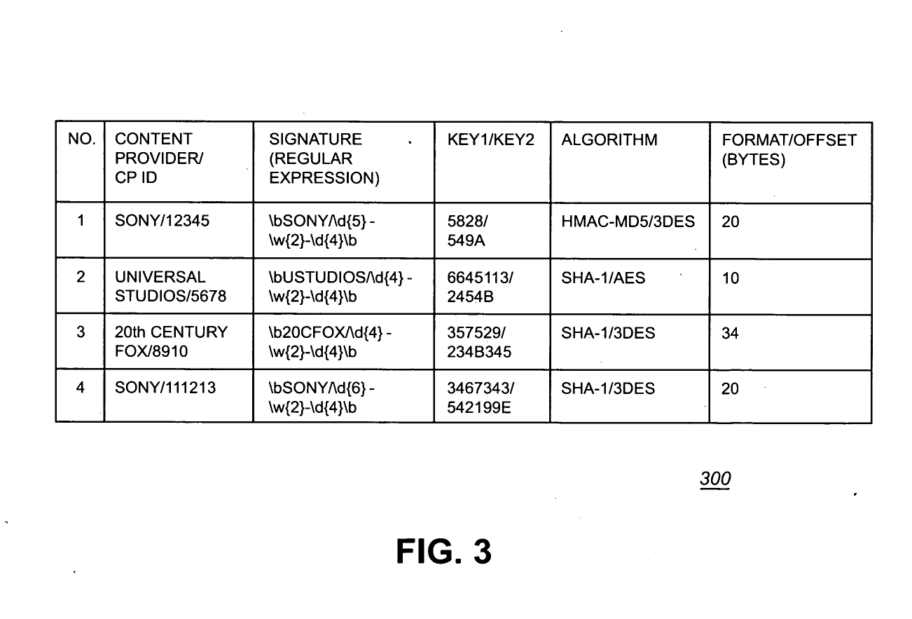

An example of the information provided to the SP in step 206 appears in FIG. 3. Thus, FIG. 3 will now be discussed before returning to a discussion of the remaining steps in the method 200.

FIG. 3 is a table of data 300 for use in network-based digital rights enforcement. The first column in the table of data 300 represents an arbitrary number used for identifying each line item. Thus, the arbitrary numbers assigned in the first column of the table of data 300 are whole numbers that increment by units of 1.

The second column in the table of data 300 represents the name of a given content provider and an arbitrary identification number for that content provider. These two components of the data contained in the second column of the table of data 300 are separated by a slash.

In various exemplary embodiments, data is stored in a database. In various exemplary embodiments, the database is organized in the form of a table, such as exemplary table of data 300. In various exemplary embodiments, such a table includes one or more search key(s).

Accordingly, in the exemplary embodiment depicted, the third column in the table of data 300 represents a regular expression of a signature that is used as a search key in the database table to retrieve the corresponding record. The corresponding record in turn contains information for the name of the content provider and content provider ID listed in the second column, and the other information listed in the table of data 300. Thus, the signature, or search key, in the third column of the table of data 300 is a regular expression that is used as an index to retrieve the record of the other information in the other columns of the table of data 300. In various exemplary embodiments, the signature, or search key, in the third column of the exemplary table of data 300, also identifies a type of license the CP granted to the distributor. In other words, in various exemplary embodiments, a particular flow is evaluated to determine whether a signature match exists with any of the entries in the third column of table of data 300, representing signatures stored in the database.

When a signature match exists, then various exemplary embodiments look at the information in the fourth, fifth and sixth columns of the table of data 300 to look for the algorithm, keys and offset for further processing the flow where the signature match was found. When a match for a particular signature in a particular flow is found, then the other columns within the table of data are considered to evaluate the information embedded in the identified flow. The key(s) and the algorithm of the fourth and fifth columns in the table of data 300 are used to decrypt the particular embedded information or perform an integrity check for the particular embedded information.

Accordingly, with reference to the sixth and final column of the table of data 300, in various exemplary embodiments the offset identifies a location within the flow where embedded content is found after a particular flow of content is detected. The flow is identified based on the signature as described above. In the embodiment depicted in exemplary table of data 300, the offset is a whole number corresponding to a number of bytes by which the data is offset. Likewise, the sixth column also represents formatting information necessary to locate embedded content in a particular data flow in various exemplary embodiments.

The fourth column in the table of data 300 represents a first key and a second key denoted as key1 and key2. Thus, as discussed in greater detail herein, in various exemplary embodiments, a first key is provided to each signature and is used to compute the MAC. Likewise, in various exemplary embodiments, a second key is provided for decryption of the UCI and purchaser ID, and any other data that is encrypted.

The fifth column in the table of data 300 is an identification of one or more algorithms. In various exemplary embodiments, the signatures, keys, algorithms, CP ID are provided by the CP to the SP. This information provides directions to the DPI/access gateway, also referred to herein as the digital rights enforcement device (DRED), regarding what information to look for and where to look for that information.

In various exemplary embodiments, as indicated in exemplary signature 300, a CP provides multiple signatures and multiple keys. For example, as indicated in the table of data 300, SONY provides the SP with multiple signatures. Thus, for example, one signature may be used for movies and another signature may be used for songs. Alternatively, in various exemplary embodiments, a plurality of signatures and keys are paired for the same type of content.

In still other exemplary embodiments, one signature indicates that a given purchaser is permitted to distribute the purchased content while another signature indicates that a given purchaser is not allowed to distribute the purchased content. Thus, in various exemplary embodiments, a plurality of signatures are provided to operate as a means of indicating whether a purchaser is permitted to further distribute the purchased content.

Returning now to a discussion of exemplary method 200, following step 206, the method proceeds to step 208. In step 208, the end user 105 requests content. Thus, during step 208, the end user 105 starts a download from another user or from the distributor server 135.

Following step 208, the method 200 proceeds to step 211. In various exemplary embodiments, the signature is used to identify content. There might be a lot of flows going through between the first network and the second network. Thus, in step 211, the DRED looks for all signatures in it's database and compares them to all the different flows. The method 200 then proceeds to step 214 where the DRED performs an analysis whether a signature match exists.

When there is a match between the signature in the DRED's database and in a particular flow, then, the method proceeds to step 216. In step 216, the DRED extracts the embedded information within the content. In other words, in step 216, when the DRED matches a flow to a signature that was provided and stored in its database in step 214, then, the DRED extracts the embedded information from the content in step 216. When extracting the embedded information in step 216, in various exemplary embodiments, an offset provides the location of the embedded information within a flow of the content.

In this manner, the DRED matches the flow/flows that have been established to the signature that was provided to the SP or stored in the DRED database. The flows are analyzed for matching signatures.

If a determination is made in step 214 that a signature match does not exist, the method 200 proceeds to step 226 where the method 200 stops. Alternatively, if a determination is made in step 214 that a signature match does exist, then the method 200 proceeds to step 216 as described above.

In step 216, the data in the data stream is extracted. In various exemplary embodiments, an offset is implemented to identify a proper location of the data for extraction. In various exemplary embodiments, the extracted data contains the UCI and the purchasers ID. In various exemplary embodiments, the extraction of the data in step 216 also includes computing a MAC based on a key and algorithm provided for a particular signature by the CP. In various exemplary embodiments this is done to ensure that the embedded information, such as UCI and Purchaser's ID, has not been modified.

Following step 216, the method 200 proceeds to step 218 where the data is analyzed. The analysis of the data in step 218 obtains the CP ID in various exemplary embodiments. Similarly, the analysis of the data in step 218 obtains an identification of the content in various exemplary embodiments. In various exemplary embodiments, the CP and content ID are used to perform the evaluation in step 220. In various exemplary embodiments, the DRED performs the analysis in step 220.

Thus, following step 218, the method 200 proceeds to step 220. In step 220 a determination is made whether the end user 105 is a legitimate user of the requested content. In various exemplary embodiments, the analysis performed in step 220 includes verification of the MAC. Thus, in various exemplary embodiments, the determination made in step 220 is made based on a network identity of the end user 105.

If a determination is made in step 220 that the end user 105 is a legitimate user of the requested content, then the method 200 proceeds to step 222. In step 222 the content is forwarded from the DRED 115 to the end user 105 through the first network 110. Following step 222, the method 200 proceeds to step 226 where the method 200 stops.

If a determination is made in step 220 that the end user 105 is not a legitimate user of the requested content, then the method 200 proceeds to step 224. In step 224, an enforcement action is taken regarding an illegitimate user.

In various exemplary embodiments, the enforcement action taken in step 224 includes the DRED 115 forwarding the end user 105 to the website of the content provider 125. In various exemplary embodiments, the enforcement action take in step 224 includes the DRED 115 dropping all packets that are contained in the particular flow or session. In various exemplary embodiments, the enforcement action taken in step 224 includes the DRED forwarding marketing information from the CP 125 to the end user 105. In other words, in various exemplary embodiments, the enforcement action taken in step 224 includes giving the end user 105 the opportunity to legitimately purchase the requested content. In various exemplary embodiments, this is performed in the form of a pop-up.

It should be apparent that, in various exemplary embodiments, the enforcement action taken in step 224 is an action coordinated between the DRED and the content provider 125. For example, in various exemplary embodiments where the enforcement action taken in step 224 includes dropping all of the packets in the particular flow, the enforcement action also includes the DRED notifying the CP 125 of the occurrence of the enforcement action. Further, in various exemplary embodiments, the DRED 115 provides the CP 125 with an IP address of the end user 105 in connection with taking the enforcement action in step 224. Similarly, in various exemplary embodiments, the DRED 115 provides the CP 125 with information regarding the content requested by the end user 105 in connection with taking the enforcement action in step 224. Further, in various exemplary embodiments, the CP 125 takes its own action towards the end user 105 and/or the distributor 135 in connection with taking enforcement action in step 224. After taking an enforcement action in step 224, the method 200 proceeds to step 226 where the method 200 stops.

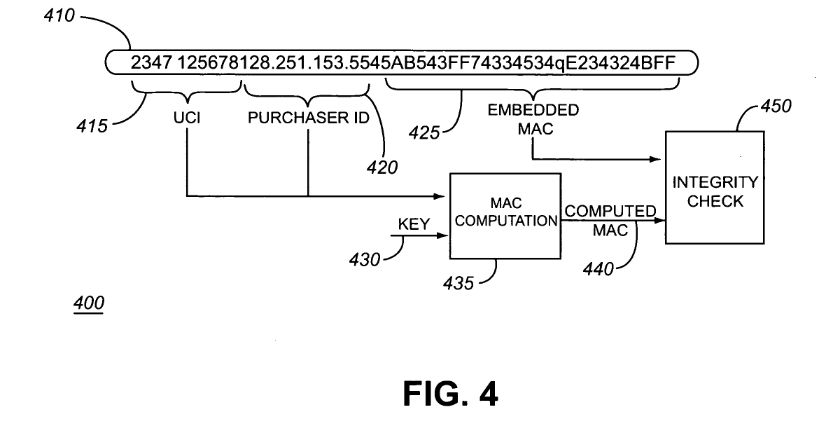

FIG. 4 is a schematic diagram of an exemplary embodiment of embedded information 400 and exemplary use of same in network-based digital rights enforcement. Exemplary embedded information 400 includes embedded data 410. Embedded data 410 includes a UCI 415, a purchaser ID 420 and an embedded MAC 425.

In connection with various method steps described herein, the UCI 415 and purchaser ID 420 are entered into a MAC computation 435 along with a key 430. Based on these inputs, in various exemplary embodiments, the MAC computation 435 yields a computed MAC 440. As depicted in connection with exemplary signature 400, the computed MAC 440 is input to an integrity check 450 along with the embedded MAC 425. The integrity check 450 thus determines the integrity and authenticity of the data by comparing the computed MAC 440 with the embedded MAC 425.

Referring again to FIG. 1, it should be apparent that, in various exemplary embodiments, the DRED 115 is positioned in different locations within the system 100. Thus, in various exemplary embodiments, the DRED 115 is positioned such that the first network 110 is between the DRED 115 and the second network 130. In such embodiments, the DRED 115 is located relatively close to the end user 105. In various such exemplary embodiments, the enforcement action taken in step 224 includes informing the end user 105 that the end user 105 is not permitted to request the content requested by the end user 105 in step 208.

In various other exemplary embodiments, the second network 130 is located between the DRED 115 and the first network 110. In some such exemplary embodiments, the DRED 115 is located relatively close to the distributor 135. Thus, in some such exemplary embodiments, the DRED focuses on the distribution level of the content. In various such exemplary embodiments, the DRED 115 includes a counter that counts distribution volume. In various exemplary embodiments, the enforcement action taken in step 224 includes informing the distributor 135 that a permissible volume of the content has been exceeded. Likewise, in various exemplary embodiments, the enforcement action taken in step 224 includes informing the distributor 135 that the distributor 135 is not allowed to distribute the content.

The subject matter described herein is believed to be of significant value even if it is not standardized. Various exemplary embodiments are believed to be a significant value-added service either by the service providers or network equipment vendors. Both service providers and network equipment vendors are believed to be attempting to access the big market of content management and associated services. Service provider are believed to be seeking to be involved in the value chain of content delivery rather than limited to simply a so-called “fat pipe” provider.

The subject matter described herein includes deployment of various exemplary embodiments in an SP's network. Thus, various exemplary embodiments afford a flexible option for SP and CP collaboration. Likewise, various exemplary embodiments afford an opportunity for taking real time action. Various exemplary embodiments enable targeting of a part or a whole of illegitimate content distribution transactions. Thus, the subject matter described herein provides desirable benefits to content providers.

In various exemplary embodiments, the policies of the SP vary depending on existing local regulations. Thus, in various exemplary embodiments, the policies implemented by the SP do not depend on local regulations that apply to the distributor 135 but do not apply to the service provider.

In various exemplary embodiments, the DRED 115 is implemented in broadband access network equipment such as a digital subscriber line (DSL) concentrator. Similarly, with rising interest in Internet protocol television (IPTV), it is believed that DRM and the enforcement of digital rights is an important issue to address.

Although the various exemplary embodiments have been described in detail with particular reference to certain exemplary aspects thereof, it should be understood that the invention is capable of other different embodiments, and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only, and do not in any way limit the invention, which is defined only by the claims. For example, although the description herein has been focused on embodiments pertaining to digital rights management, it should be apparent that the same concepts can be applied to other embodiments outside the realm of digital rights management as a method of fingerprinting data.

What is claimed is:

1. A method of network-based digital rights enforcement, comprising:
embedding information into digital content requested by an end user;
providing a signature for the digital content to a service provider;
providing a key to the service provider, the key being necessary for reading the information embedded into the digital content;
providing an algorithm to the service provider for extracting the information embedded into the digital content;
providing an identification to the service provider of a content provider that provides the digital content;
extracting the signature from a flow of the digital content requested by the end user;
analyzing the flow to determine whether a signature match exists; and
determining whether the end user is a legitimate authorized user of the requested digital content.

2. The method of network-based digital rights enforcement, according to claim 1, further comprising forwarding the requested digital content to the end user, when it is determined that the end user is a legitimate authorized user of the requested digital content.

3. The method of network-based digital rights enforcement, according to claim 1, further comprising taking an enforcement action in response to the end user's request for the digital content when it is determined that the end user is not a legitimate authorized user of the requested digital content.

4. The method of network-based digital rights enforcement, according to claim 3, wherein the enforcement action includes forwarding a website of the content provider to the end user.

5. The method of network-based digital rights enforcement, according to claim 3, wherein the enforcement action includes dropping all packets associated with the end user's request for the digital content.

6. The method of network-based digital rights enforcement, according to claim 3, wherein the enforcement action includes forwarding marketing information to the end user, the marketing information including information to enable the end user to legitimately purchase the requested digital content.

7. The method of network-based digital rights enforcement, according to claim 3, wherein the enforcement action includes displaying a pop-up on a computer screen of the end user.

8. The method of network-based digital rights enforcement, according to claim 3, wherein the enforcement action includes coordinating between a digital rights enforcement device and the content provider.

9. The method of network-based digital rights enforcement, according to claim 8, wherein the digital rights enforcement device notifies the content provider of the end user's request for the digital content.

10. The method of network-based digital rights enforcement, according to claim 8, wherein the digital rights enforcement device provides the content provider with an identification of the end user.

11. The method of network-based digital rights enforcement, according to claim 10, wherein the identification of the end user includes an Internet protocol address of the end user.

12. The method of network-based digital rights enforcement, according to claim 8, wherein the digital rights enforcement device provides the content provider with an identification of the digital content requested by the end user.

13. The method of network-based digital rights enforcement, according to claim 3, wherein the enforcement action is taken by the content provider.

14. The method of network-based digital rights enforcement, according to claim 1, further comprising extracting data from the requested digital content.

15. The method of network-based digital rights enforcement, according to claim 14, wherein the data is extracted using an offset.

16. The method of network-based digital rights enforcement, according to claim 14, wherein the extracted data includes a universal content identifier.

17. The method of network-based digital rights enforcement, according to claim 16, wherein the extracted data includes an identification of an owner of the content.

18. The method of network-based digital rights enforcement, according to claim 14, further comprising computing a message authentication code for the extracted data.

19. The method of network-based digital rights enforcement, according to claim 18, wherein the computed message authentication code is based on the key and on the algorithm.

20. The method of network-based digital rights enforcement, according to claim 1, further comprising analyzing data extracted from the requested digital content.

21. The method of network-based digital rights enforcement, according to claim 20, wherein analyzing the data extracted from the requested digital content includes determining an identification of the content.

22. A digital rights enforcement device, comprising:
means for reading information embedded into digital content requested by an end user;
means for applying a key in order to read the information embedded into the digital content;
means for executing an algorithm to extract the information embedded into the digital content;
means for recognizing an identification of a content provider that provides the digital content;
means for extracting a signature for the digital content from a flow of the digital content;
means for analyzing the signature to determine whether a signature match exists; and
means for determining whether the end user is a legitimate authorized user of the requested digital content.

23. A method of fingerprinting data, comprising:
embedding information into data requested by an end user;
providing a signature for the data to a service provider;
providing a key to the service provider, the key being necessary for reading the information embedded into the data;
providing an algorithm to the service provider for extracting the information embedded into the data;
providing an identification to the service provider of a data provider that provides the data;
extracting the signature from a flow of the data requested by the end user;
analyzing the flow to determine whether a signature match exists; and
determining whether the end user is a legitimate authorized user of the requested data.

24. A digital rights enforcement device, comprising:
means for reading information embedded into digital content requested by an end user;
means for applying a key in order to read the information embedded into the digital content;
means for executing an algorithm to extract the information embedded into the digital content;
means for recognizing an identification of a content provider that provides the digital content;
means for extracting a signature for the digital content from a flow of the digital content;
means for analyzing the signature to determine whether a signature match exists; and
means for counting a distribution volume of the requested digital content.

25. The digital rights enforcement device, according to claim 24, further comprising means for taking an enforcement action when a count of the distribution volume exceeds a predetermined threshold.
